(19) United States
(12) Patent Application Publication
(10) Pub. No.: US 2013/0239112 A1
(43) Pub. Date: Sep. 12, 2013

(54) INFORMATION PROCESSING SYSTEM

(71) Applicants: Takeshi Kato, Akishima (JP); Yasuhiro Asa, Tama (JP); Masato Hayashi, Hachioji (JP); Tatsuya Saito, Kunitachi (JP)

(72) Inventors: Takeshi Kato, Akishima (JP); Yasuhiro Asa, Tama (JP); Masato Hayashi, Hachioji (JP); Tatsuya Saito, Kunitachi (JP)

(73) Assignee: Hitachi, Ltd.

(21) Appl. No.: 13/884,464

(22) PCT Filed: Mar. 23, 2011
(86) PCT No.: PCT/JP2011/056894

§ 371 Date: May 9, 2013

(51) Int. Cl. G06F 9/50

(52) U.S. Cl. CPC G06F 9/5077
USPC 718/1

(57) ABSTRACT

It is an object of the invention to provide an information processing system which achieves efficient physical resource allocation to a virtual resource. An information processing system of the invention includes a plurality of physical resources mutually connected over a network, and an operating management computer which manages a virtual resource into which a plurality of physical resources are logically aggregated. The information processing system determines physical resources to be logically aggregated into and be allocated to a virtual resource on the basis of a resource usage amount of a workload to be processed by the information processing system and configuration information on the plurality of physical resources.

### TECHNICAL FIELD

The present invention relates to an information processing system including physical resources such as a server apparatus, a memory, and a processor and particularly relates to an information processing system including a virtual resource into which physical resources are logically aggregated.

### BACKGROUND ART

A flexible and efficient data center that functions as an information processing base has been demanded in order to satisfy business needs which are changing day by day and technological needs for energy saving and resource saving. Accordingly, information processing systems are shifting to a fabric-based architecture in which fine-granularity physical resources including a processor, a memory, a storage, a network are connected over a network so that those physical resources are adaptively combined virtually for polymorphism.

In the past, US Patent Application Publication No. 2005/0039180, Description (PTL 1), discloses a technology which provides one virtual Symmetric Multiprocessing (SMP) machine having a Non-Uniform Memory Access (NUMA)-like shared memory acquired by connecting a plurality of compute nodes including processors and memories over a network and logically aggregating those nodes for virtualization.

JP-A-2009-199395 (PTL 2) and JP-A-2010-61278 (PTL 3) disclose a method including logically partitioning a physical server (node) including a processor and a memory into virtual servers and arranging the virtual servers to physical servers under constraints or on the basis of resource information.

JP-A-2007-35045 (PTL 4), JP-A-2007-310884 (PTL 5), and JP-A-2009-506462 (PTL 6) disclose an architecture in which hardware (node) including a processor and a memory is logically partitioned into hierarchically virtualized first level and second level.

### CITATION LIST

### Patent Literature

PTL 1: U.S. Patent Application Publication No. 2005/0039180, Description
PTL 2: JP-A-2009-199395
PTL 3: JP-A-2010-61278
PTL 4: JP-A-2007-35045
PTL 5: JP-A-2007-310884
PTL 6: JP-A-2009-506462

### SUMMARY OF INVENTION

### Technical Problem

For improved information processing performances and improved efficiency of operation regarding power consumption in an information processing system, physical resources may be required to be combined appropriately and flexibly. It is desirable to virtualize and logically aggregate physical resources in accordance with an information processing request, that is, its workload.

However, Patent Literature 1 discloses virtualization software which logically aggregates a plurality of compute nodes but does not mention how many compute nodes are to be aggregated in accordance with a workload of a virtual SMP machine.

Patent Literature 2 and Patent Literature 3 address a case with a smaller resource to be allocated to a virtual server than a resource of a physical server and do not consider how a large virtual server is to be arranged to a plurality of physical servers, as disclosed in Patent Literature 1.

In the architectures disclosed in Patent Literatures 4 to 6, a first level virtualization is limited within a node, and Patent Literatures 4 to 6 do not mention how resources are allocated to first level and second level virtual machines if the number of nodes is increased to a plurality of nodes.

It is an object of the invention to provide an information processing system which aggregates physical resources for improved efficiency for virtualized workloads.

### Solution to Problem

An information processing system of the invention includes a plurality of physical resources connected to one another over a network, and an operating management computer which manages a virtual resource into which the plurality of physical resources are logically aggregated, wherein physical resources to be logically aggregated into and allocated to the virtual resource are determined on the basis of a resource usage amount of a workload to be processed by the information processing system and the configuration information of the plurality of physical resources.

### Advantageous Effects of Invention

According to the present invention, an information processing system may be provided which allows efficient allocation of physical resources to a virtual resource in accordance with its workload.

### BRIEF DESCRIPTION OF DRAWINGS

FIG. 1 is a configuration diagram illustrating an information processing system according to Embodiment 1 of the invention.

FIG. 2 is a configuration diagram illustrating an information processing system according to Embodiment 2 of the invention.

FIG. 3 is a diagram illustrating an example of a resource allocation method in an information processing system of the invention.

FIG. 4 is a diagram illustrating an example of a resource allocation method in an information processing system of the invention.

### DESCRIPTION OF EMBODIMENTS

Embodiments of the invention will be described below with reference to drawings.

### Embodiment 1

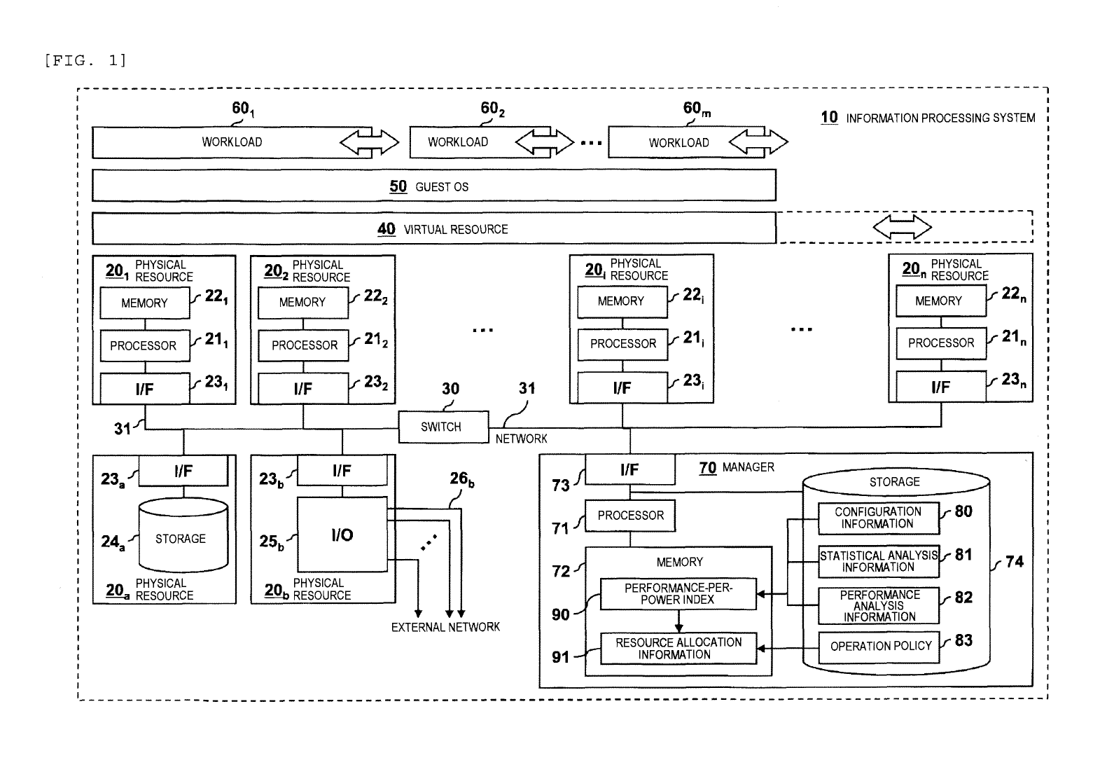

FIG. 1 is a configuration diagram illustrating an information processing system 10 according to Embodiment 1 of the invention. The information processing system 10 has physical resources 20₁ to 20ₙ, 20ₐ and 20_{b}, which are mutually connected through a switch 30 and a network 31. In the information processing system 10, a virtual resource 40 is provided into which physical resources 20₁ to 20ₙ are logically aggregated, and a guest OS 50 runs on the virtual resource 40, and workloads 60₁ to 60ₘ are executed on the guest OS 50. The physical resources 20₁ to 20ₙ are allocated to the virtual resource 40 as the situation demands. In other words, variable amounts of physical resources 20₁ to 20ₙ are aggregated into the virtual resource 40. The information processing system 10 further includes a manager 70 that is a computer responsible for operating management of the physical resources 20₁ to 20ₙ, 20ₐ, and 20_{b}, virtual resource 40, and workloads 60₁ to 60ₘ. The virtual resource 40 may be a virtual server, for example. The workloads 60₁ to 60ₘ may be applications, for example.

The physical resources 20₁ to 20ₙ are server apparatuses, that is, compute nodes including processors 21₁ to 21ₙ and memories 22₁ to 22ₙ corresponding to fine-granularity physical resources. The physical resources 20₁ to 20ₙ further include interface units (I/F) 23₁ to 23ₙ to/from the network 31. The physical resource 20ₐ is a node including a storage apparatus 24ₐ and an I/F 23ₐ to/from the network 31. The physical resource 20_{b} is a node including an input/output device (I/O) 25_{b} connecting to an external network 26_{b} and an I/F 23_{b} to/from the network 31.

The manager 70 includes a processor 71, a memory 72, an interface unit (I/F) 73 to/from the network 31, and a storage 74. The storage 74 stores configuration information 80 on the physical resources 20₁ to 20ₙ, 20ₐ and 20_{b}, statistical analysis information 81 and performance analysis information 82 on the workloads 60₁ to 60ₘ, and an operation policy 83.

The configuration information 80 on the physical resources 20₁ to 20ₙ, 20ₐ and 20_{b} may contain the model numbers, clock frequencies, the numbers of cores, and numbers of threads of the processors 21₁ to 21ₙ, the models, capacitances, operation frequencies, and throughputs of the memories 22₁ to 22ₙ, the capacity and throughput of the storage 24ₐ and the interface, number of ports, and transmission rate of the I/O 25_{b}. The configuration information 80 may further contain information on power consumption values to resource usage amounts of the physical resources 20₁ to 20ₙ, 20ₐ and 20_{b}. The information on power consumption values to resource usage amounts of the physical resources 20₁ to 20ₙ, 20ₐ and 20_{b} contained in the configuration information 80 may be a relational expression of power consumption values to resource usage amounts of the physical resources 20₁ to 20ₙ, 20ₐ and 20_{b}.

The statistical analysis information 81 contains history values of resource usage amounts in the virtual resource 40 of the workloads 60₁ to 60ₘ and history values of the resource usage amounts in the physical resources 20₁ to 20ₙ used through the virtual resource 40. The statistical analysis information 81 further contains a mean and a deviation of resource usage amounts in the virtual resource 40 of the workloads 60₁ to 60ₘ acquired by performing statistical analysis on the history values and a mean and a deviation of the resource usage amounts in the physical resources 20₁ to 20ₙ used through the virtual resource 40. When physical resources are allocated to the virtual resource 40, the mean is used for a forecast value for a resource usage amount and the deviation is used for a confidential interval for a resource usage amount. The statistical analysis information 81 may further contain a forecast value and confidential interval (deviation) including a future fluctuation predicted as a result of a time series analysis and correspondence relationship information between workloads 60₁ to 60ₘ and physical resources 20₁ to 20ₙ, 20ₐ, and 20_{b}.

The performance analysis information 82 contains a profile log regarding an event relating to a task, a process or a thread, a concurrency of threads and their resource usage amounts and communications among the physical resources 20₁ to 20ₙ, 20ₐ, and 20_{b} of the workloads 60₁ to 60ₘ. The performance analysis information 82 further contains correspondence relationship information on profiles and the physical resources 20₁ to 20ₙ, 20ₐ, and 20_{b}.

The operation policy 83 contains a policy rule describing, for the workloads 60₁ to 60ₘ, which one of a processing performance, power consumption and power efficiency for processing performance is to be emphasized for physical resource allocation control to the virtual resource 40. The operation policy 83 further contains a criterion, a constraint, a reliability condition and so on for resource allocation control.

The manager 70 includes a first means for acquiring the configuration information 80. The first means for acquiring the configuration information 80 accesses each physical resource to acquire the configuration information 80 thereon. The first means may acquire the configuration information 80 in response to an input by an operator.

The manager 70 further includes a second means for determining physical resources to be logically aggregated into and allocated to the virtual resource 40 among the physical resources 20₁ to 20ₙ on the basis of the resource usage amount and configuration information 80 of workloads to be processed by the information processing system 10.

The determination of resources to be allocated to the virtual resource 40 among the physical resources 20₁ to 20ₙ by the second means may include first referring to forecast values and confidential intervals of resource usage amounts from statistical analysis information 81 on the workloads 60₁ to 60ₘ, acquiring a sufficient size of the virtual resource 40 for the workloads 60₁ to 60ₘ and determining the physical resource allocation matched with the acquired size. Furthermore, the forecast values and confidential intervals may be corrected on the basis of a correlation between history values in the statistical analysis information 81 and profile logs in the performance analysis information 82, and the total sum of the corrected forecast values and the root mean square of the deviations as the corrected confidential intervals may be calculated. When the correction is performed, how much the processing performance will be increased or decreased, whether the resources allocated by comparing them with their appropriate values will be sufficient or not, to how many physical resources the workloads 60₁ to 60ₘ are to be distributed through the virtual resource 40, and the like may be evaluated by assuming that resources are allocated to the workloads 60₁ to 60ₘ beyond or under the correction forecast value. In the same manner, how much the power consumption will be increased or decreased may be evaluated with reference to the corrected forecast values and the configuration information 80 on the physical resources 20₁ to 20ₙ, 20ₐ, and 20_{b}.

When the second means determines physical resources to be allocated to the virtual resource 40, the second means may be caused to refer to the operation policy 83 and allocate the physical resources 20₁ to 20ₙ to the virtual resource 40 in priority order (or giving them priority levels) on the basis of the processing performances, power consumptions or power efficiencies to the processing performances of the physical resources 20₁ to 20ₙ. In other words, the allocation to the virtual resource 40 by prioritizing one with high processing performance, one with low power consumption or one with high power efficiency to the processing performance among the physical resources 20₁ to 20ₙ allows more highly efficient allocation of physical resources to the virtual resource 40.

The manager 70 includes a third means for acquiring a processing performance index, a power consumption index or power efficiency-to-processing performance index so that the second means is caused to allocate the physical resources 20₁ to 20ₙ to the virtual resource 40 on the basis of the processing performances, power consumptions or power efficiencies to processing performances, that is, on the basis of the priority levels of allocation of the physical resources 20₁ to 20ₙ to the virtual resource 40. Hereinafter, the processing performance index, power consumption index or power efficiency-to-processing performance index will collectively be called a performance-per-power index 90. The third means calculates the performance-per-power indices 90 of the physical resources 20₁ to 20ₙ for the workloads 60₁ to 60ₘ on the basis of the configuration information 80, statistical analysis information 81, and performance analysis information 82.

For example, in order to acquire a processing performance index, the third means calculates the performance-per-power index 90 on the basis of a clock frequency of the processor 71, an operation frequency of memory, a concurrency of threads of workloads, and the like. For example, in order to acquire a power consumption index, the third means calculates the performance-per-power index 90 on the basis of power consumption values to the resource usage amounts of the physical resources 20₁ to 20ₙ, a mean of the resource usage amounts of the physical resources 20₁ to 20ₙ used through the virtual resource 40, and the like. For example, in order to acquire a power-efficiency-to-processing performance index, the third means calculates the performance-per-power index 90 on the basis of a clock frequency of the processor 71, an operation frequency of memory, a concurrency of threads of workloads, power consumption values to the resource usage amounts of the physical resources 20₁ to 20ₙ, a mean of the resource usage amounts of the physical resources 20₁ to 20ₙ used through the virtual resource 40, and the like. The power efficiency to processing performance may refer to a processing performance of a physical resource per unit power consumption, for example.

The manager 70 further includes a fourth means for controlling resource allocation of the physical resources 20₁ to 20ₙ to the virtual resource 40. The fourth means controls resource allocation of the physical resources 20₁ to 20ₙ to the virtual resource 40 on the basis of the determination of resource allocation of the physical resources 20₁ to 20ₙ to the virtual resource 40 by the second means, generates resource allocation information 91 and saves information on control in the memory 72.

The first to fourth means above are installed in the manager 70 and are implemented by a program which operates the processor 71, memory 72, I/F 73, and storage 74.

With the information processing system 10 of Embodiment 1 of the invention, resources necessary for processing the workloads 60₁ to 60ₘ by the information processing system 10 may be reserved and at the same time the workloads 60₁ to 60ₘ may be aggregated. The aggregation of workloads allows pause or stop of a physical resource that is not allocated to a virtual resource so that the reduction of the power consumption of the information processing system 10 may be attempted. The control over allocation of the physical resources 20₁ to 20ₙ to the virtual resource 40 on the basis of the performance-per-power index 90 for the workloads 60₁ to 60ₘ may allow aggregation of workloads optimized with the processing performance, power consumption, and the processing performance to the power consumption under an operation policy. Therefore, according to the invention, an information processing system may be provided which may achieve efficient physical resource allocation to a virtual resource according to a workload. Consequently, an information processing base such as a data center may be provided which may be adapted to various needs and changing needs and may reduce its operation costs and power costs.

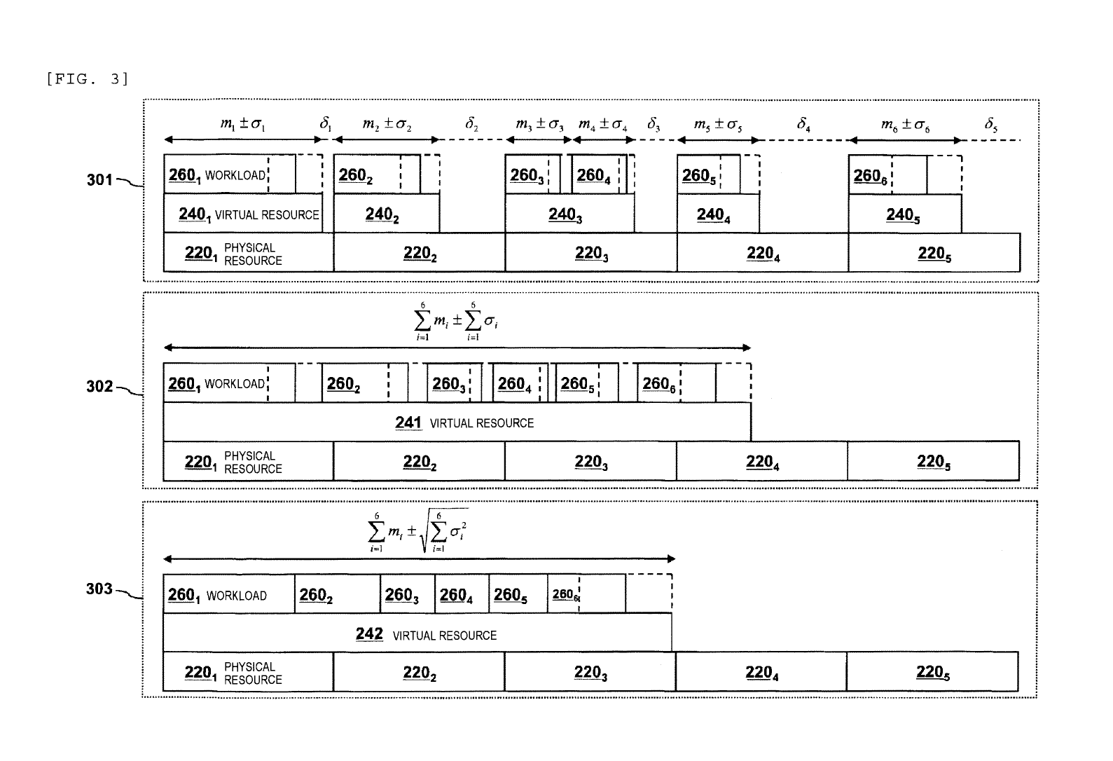

FIG. 3 illustrates an example of a resource allocation method in the information processing system 10. FIG. 3 illustrates a relationship among physical resource, virtual resource and workload in focus by omitting the configuration of the information processing system as illustrated in FIG. 1 for easy understanding. It is assumed here for easy understanding that the physical resources 20₁ to 20ₙ are server apparatuses (compute nodes) and n is equal to 5, that is, five server apparatuses are provided. Thus, five server apparatuses are illustrated as physical resources 220₁ to 220₅.

FIG. 3 illustrates a method 301 in which the physical resources 220₁ to 220₅ are allocated to the virtual resources 240₁ to 240₅, respectively, for comparison with the information processing system 10 of the invention. Workloads 260₁ to 260₆ are allocated to virtual resources 240₁ to 240₅.

It is assumed here that the means that are forecast values for the resource usage amounts of the workloads 260₁ to 260₆ are m₁ to m₆, and the deviations that are confidential intervals are σ₁ to σ₆. An allocation method represented by the method 301 for physical resource allocation sets the sizes of the virtual resources 240₁ to 240₅ and allocates resources of the physical resources 220₁ to 220₅ to the virtual resources 240₁ to 240₅, respectively, in consideration of the values acquired by adding σ₁ to σ₆ to m₁ to m₆, respectively.

The workloads 260₃ and 260₄ are aggregated into the physical resource 220₃ through the virtual resource 240₃, for example, if the resource usage amounts by the workloads are small. However, even if the aggregation is performed, the virtual resources 240₁ to 240₅ do not exceed the boundaries of the physical resources 220₁ to 220₅, and therefore physical surplus resources δ1 to δ5 occur in the physical resources 220₁ to 220₅, respectively. Furthermore, because all physical resources, that is, server apparatuses here are used, the physical resources 220₁ to 220₅ may not be paused or stopped.

A method 302 in FIG. 3 is an example of a method for allocating physical resources to a virtual resource in the information processing system 10 of Embodiment 1 of the present invention. In the method 302, the information processing system has the same physical resources 220₁ to 220₅ as those in the method 301 in FIG. 3, and the same workloads 260₁ to 260₆ as those of the method 301 are to be processed on the virtual resource 241 into which the physical resources 220₁ to 220₅ are logically aggregated. The physical resources 220₁ to 220₅ are allocated to the virtual resource 241 in consideration of the sum value of a total sum of the means m₁ to m₆ that are forecast values of the resource usage amounts of the workloads 260₁ to 260₆ and a total sum of the deviations σ₁ to σ₆ as their confidential intervals. In the method 302, because the workloads 260₁ to 260₆ are aggregated to the virtual resource 241 beyond the boundaries of the physical resources 220₁ to 220₅, the surplus resources δ1 to δ5 as seen in the method 301 may be reduced. Pausing or stopping the physical resource 220₅ that is not allocated to the virtual resource 241 may reduce the power consumption of the information processing system. Approximately half of the physical resource 220₄ is allocated to the virtual resource 241 because only a part of cores of the processor in the physical resource 220₄ may be allocated to the virtual resource 241 when the physical resource 220₄ has a multi-core processor, for example, and an efficient operation may be allowed including allocating a surplus resource of the physical resource 220₄ to another virtual resource.

A method 303 in FIG. 3 is another example of a method for allocating physical resources to a virtual resource in the information processing system 10 of Embodiment 1 of the present invention. In the method 303, the information processing system has the same physical resources 220₁ to 220₅ as those in the method 301 and the method 302, and the same workloads 260₁ to 260₆ as those of the method 301 and the method 302 are to be processed on the virtual resource 242 into which the physical resources 220₁ to 220₅ are logically aggregated. The physical resources 220₁ to 220₅ are allocated to the virtual resource 242 in consideration of the sum value of a total sum of means m₁ to m₆ that are forecast values of the resource usage amounts of the workloads 260₁ to 260₅ and root mean square values (such as combined standard deviations) of deviations σ₁ to σ₆ as their confidential intervals. The allocation method represented by the method 303 uses statistic characteristics of the workloads 260₁ to 260₆ and thus uses their root mean square values instead of the total sum of σ₁ to σ₆. Thus, the workloads 260₁ to 260₆ may be aggregated more efficiently than the method 302, and the physical resources 220₄ and 220₅ may be paused or stopped so that the power consumption of the information processing system may further be reduced.

The allocation to a virtual resource has been described with reference to FIG. 3, without giving the priority levels of the physical resources in particular. For example, when physical resources having similar specifications are provided, the allocating methods represented by the method 302 and the method 303 are effective. On the other hand, when physical resources having different specifications are provided, the allocating methods represented by the method 302 and the method 303 may not necessarily be efficient.

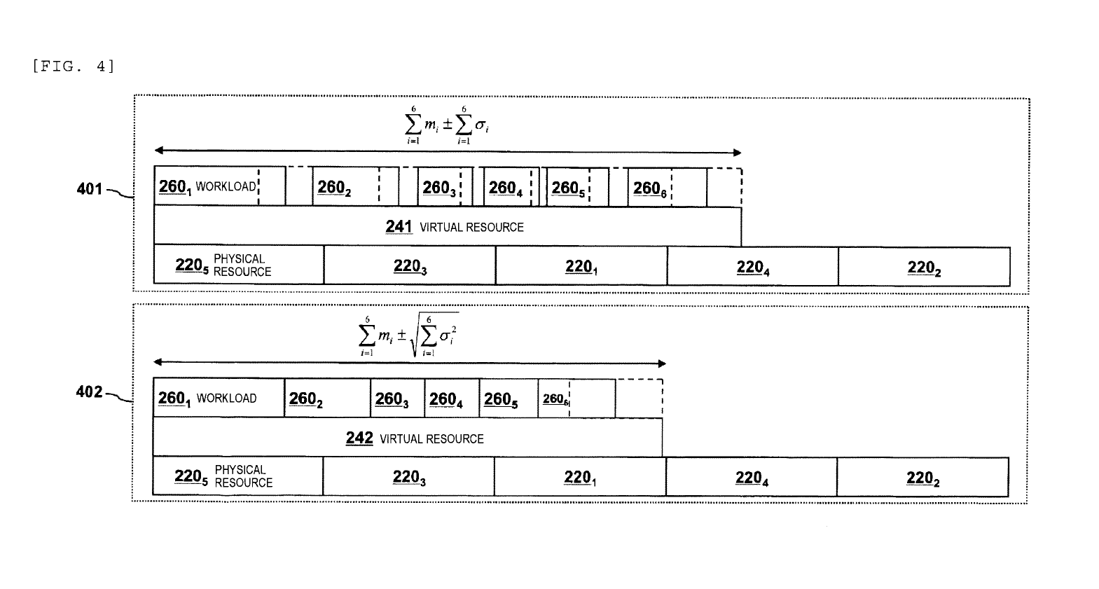

Accordingly, FIG. 4 illustrates a case where physical resources having priority levels are allocated to a virtual resource. In other words, the allocation method illustrated in FIG. 4 allocates physical resources to a virtual resource on the basis of results of calculations of the performance-per-power indices 90 of the physical resources to workloads by the third means.

A method 401 represents an allocation method when the physical resource 220₅ has the highest priority level and the physical resources 220₃, 220₁, 220₄, 220₂ have lower priority levels in the decreasing order from the calculation results of their performance-per-power indices 90. The allocation method represented by the method 401 pauses or stops the physical resource 220₂ so that the power consumption of the information processing system may be reduced. Causing the physical resource 220₂ with the lowest priority level among the physical resources not to work results in processing the workloads 260₁ to 260₆ by physical resources having higher priority levels among the physical resources, which allows higher efficiency of processing.

A method 402 represents a case where the physical resources 220₁ to 220₅ are allocated to the virtual resource 242 in consideration of the sum value of a total sum of means m₁ to m₆ that are forecast values of the resource usage amounts of the workloads 260₁ to 260₆ and root mean square values (such as combined standard deviations) of deviations σ₁ to σ₆ as their confidential intervals. The allocation method represented by the method 402 uses statistic characteristics of the workloads 260₁ to 260₆ and thus uses their root mean square values instead of the total sum of σ₁ to σ₆. Thus, the workloads 260₁ to 260₆ may be aggregated more efficiently than the method 401, and the physical resources 220₄ and 220₂ may be paused or stopped so that the power consumption of the information processing system may further be reduced. Causing the physical resources 220₄ and 220₂ with lower priority levels among the physical resources not to work results in processing the workloads 260₁ to 260₆ by physical resources having higher priority levels among the physical resources, which allows higher efficiency of processing.

Comparing the method 401 and the method 402, resources are allocated with a sufficient margin in the former case while the latter case provides a higher effect to reduce the power consumption. In other words, in accordance with the operation policy 83 described with reference to FIG. 1, the former is preferably applied to a case where processing performance is emphasized while the latter is preferably applied to a case where the power consumption or power efficiency to processing performance is emphasized.

Notably, using a total sum of means and a total sum or root mean square value of deviations in FIG. 3 and FIG. 4, an appropriate statistic index may be used in accordance with a characteristic of a workload such as transaction processing or batch processing, a periodicity or a sudden characteristic of time series changes of a workload or a mutually dependent relationship of workloads, for example.

### Embodiment 2

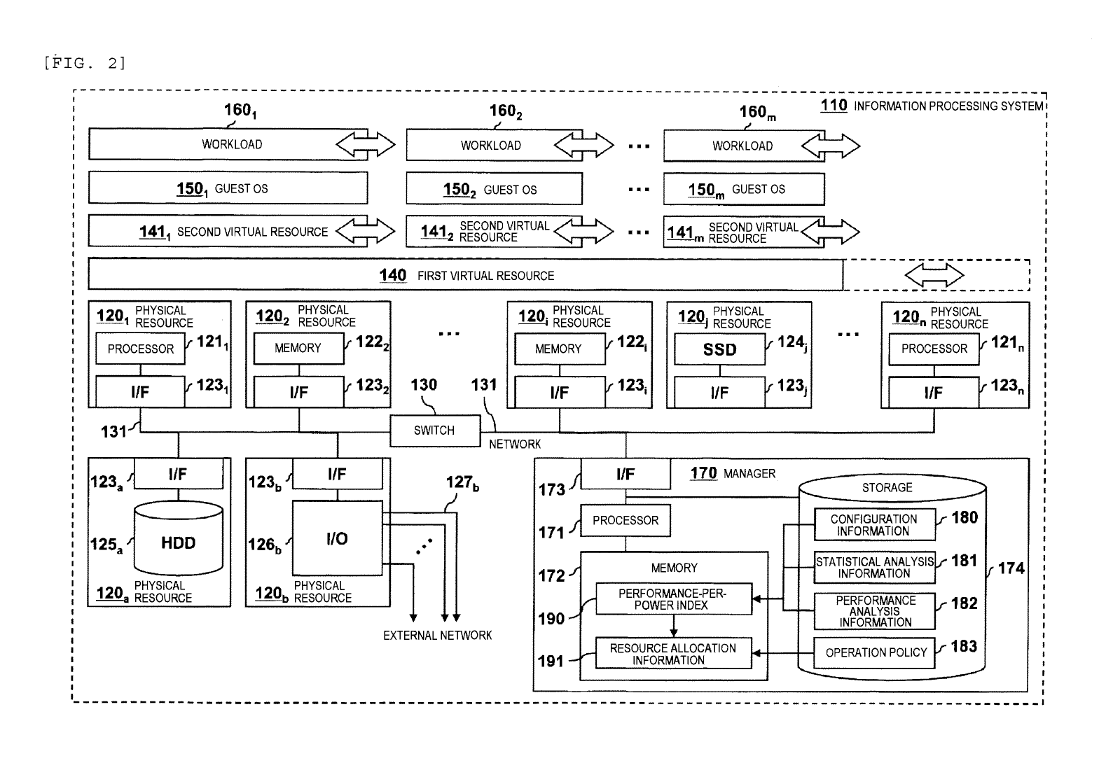

FIG. 2 is a configuration diagram illustrating an information processing system 110 of Embodiment 2 of the invention. Differences from Embodiment 1 will be mainly described below.

The information processing system 110 has physical resources 120₁ to 120ₙ, 120ₐ and 120_{b}, which are mutually connected through a switch 130 and a network 131. In the information processing system 110, a first virtual resource 140 is provided into which the physical resources 120₁ to 120ₙ are logically aggregated, and second virtual resources 140₁ to 140ₘ are provided which logically partition the first virtual resource 140. Guest OSs 150₁ to 150ₘ run on the second virtual resources 140₁ to 140ₘ, and workloads 160₁ to 160ₘ are executed on the guest OSs 150₁ to 150ₘ. The physical resources 120₁ to 120ₙ are allocated to the first virtual resource 140 as the situation demands. In other words, variable amounts of physical resources 120₁ to 120ₙ are aggregated into the first virtual resource 140. The information processing system 110 further includes a manager 170 that is a computer responsible for operating management of the physical resources 120₁ to 120ₙ, 120ₐ, and 120_{b}, the first virtual resource 140, the second virtual resources 141₁ to 141ₘ and the workloads 160₁ to 160ₘ.

The physical resources 120₁ to 120ₙ are nodes which may include processors 121₁ and 121ₙ, memories 122₂ and 122ᵢ, and a solid-state storage drive (SSD) 124ⱼ, which correspond to the fine-granularity physical resources. The physical resources 120₁ to 120ₙ further include interface units (I/F) 123₁ to 123ₙ to/from the network 131. The physical resource 120ₐ is a node including a hard disk drive (HDD) 125ₐ and an interface unit (I/F) 123ₐ. The physical resource 120_{b} is a node including an input/output device (I/O) 126_{b} connecting to an external network 127_{b} and an I/F 123_{b} to/from the network 31.

Like the information processing system 10 of Embodiment 1, the manager 170 has the aforementioned first to fourth means and allocates the physical resources 120₁ to 120ₙ. However, this embodiment is different from Embodiment 1 in that each of the physical resources 120₁ to 120ₙ may not necessarily include the same elements. However, it is the same as Embodiment 1 that the processor, memory, and SSD included in each of the physical resources 120₁ to 120ₙ are fine-granularity physical resources. Thus, the resource allocation of the physical resource 120₁ to 120ₙ to the first virtual resource 140 may be performed by the first to fourth means above in the same manner as in Embodiment 1.

In the information processing system 110, the second virtual resources 141₁ to 141ₘ are allocated for each workload. Thus, the operation policy may be set for each of the second virtual resources, and the allocation may be optimized more finely than the information processing system 10 of Embodiment 1.

### REFERENCE SIGN LIST

10 information processing system
20₁ to 20ₙ, 20ₐ, 20_{b} physical resource
21₁ to 21ₙ processor
22₁ to 22ₙ memory
23₁ to 23ₙ, 23ₐ, 23_{b} I/F
24ₐ storage
25_{b} I/O
26_{b} external network
30 switch
31 network
40 virtual resource
50 guest OS
60₁ to 60ₘ workload
70 manager
71 processor
72 memory
73 I/F
74 storage
80 configuration information
81 statistical analysis information
82 performance analysis information
83 operation policy
90 performance-per-power index
91 resource allocation information
110 information processing system
120₁ to 120ₙ, 120ₐ, 120_{b} physical resource
121₁, 121ₙ processor
122₂, 122ᵢ memory
123₁ to 123ₙ, 123ₐ, 123_{b} I/F
124ⱼ SSD
125ₐ HDD
126_{b} I/O
127_{b} external network
130 switch
131 network
140 first virtual resource
141₁ to 141ₘ second virtual resource
150₁ to 151ₘ guest OS
160₁ to 160ₘ workload
170 manager
171 processor
172 memory
173 I/F
174 storage
180 configuration information
181 statistical analysis information
182 performance analysis information
183 operation policy
190 performance-per-power index
191 resource allocation information
220₁ to 220₅ physical resource
240₁ to 240₅, 241, 242 virtual resource
260₁ to 260₆ workload

1. An information processing system, comprising:
a plurality of physical resources connected to one another over a network; and
an operating management computer which manages a virtual resource into which the plurality of physical resources are logically aggregated,
wherein the operating management computer includes
a first means for acquiring configuration information on the plurality of physical resources; and
a second means for determining a physical resource to be logically aggregated into and allocated to the virtual resource among the plurality of physical resources on the basis of a resource usage amount of a workload to be processed by the information processing system and the configuration information.

2. The information processing system according to claim 1, wherein the second means determines physical resources to be allocated by prioritizing physical resources with higher power efficiency to processing performance among the plurality of physical resources to the virtual resource.

3. The information processing system according to claim 2, wherein a physical resource with high power efficiency to processing performance to be prioritized by the second means among the plurality of physical resources is a physical resource with high processing performance per unit power consumption among the plurality of physical resources.

4. The information processing system according to claim 1, wherein the second means determines a physical resource to be allocated to the virtual resource by prioritizing physical resources with higher processing performance among the plurality of physical resources.

5. The information processing system according to claim 1, wherein the second means determines a physical resource to be allocated to the virtual resource by prioritizing physical resources having smaller power consumption among the plurality of physical resources.

6. The information processing system according to claim 1, wherein the plurality of physical resources are server apparatuses;
each of the server apparatuses includes a processor and a memory; and
the configuration information contains a clock frequency of the processor and a capacity of the memory.

7. The information processing system according to claim 6, wherein the workload is an application.

8. The information processing system according to claim 1, wherein the plurality of physical resources are processors; and
the configuration information contains clock frequencies of the processors.

9. An information processing system, comprising:
a plurality of physical resources connected to one another over a network; and
an operating management computer which manages a virtual resource into which the plurality of physical resources are logically aggregated,
wherein the operating management computer includes
a first means for acquiring configuration information of the plurality of physical resources;
a second means for determining a physical resource to be logically aggregated into and allocated to the virtual resource among the plurality of physical resources on the basis of a resource usage amount of a workload to be processed by the information processing system, a concurrency of threads and the configuration information.

10. The information processing system according to claim 9, wherein the second means determines physical resources to be allocated by prioritizing physical resources with higher power efficiency to processing performance among the plurality of physical resource to the virtual resource.

11. The information processing system according to claim 10, wherein a physical resource with high power efficiency to processing performance to be prioritized by the second means among the plurality of physical resources is a physical resource with high processing performance per unit power consumption among the plurality of physical resources.

12. The information processing system according to claim 9, wherein the plurality of physical resources are server apparatuses;
each of the server apparatuses includes a processor and a memory; and
the configuration information contains the number of threads, a clock frequency of the processor and a capacity of the memory.

13. The information processing system according to claim 12, wherein the workload is an application.
